(19) United States
(12) Patent Application Publication
(10) Pub. No.: US 2026/0214446 A1
(43) Pub. Date: Jul. 23, 2026

(54) CONTROLLER METHOD AND APPARATUS

(71) Applicant: Sony Interactive Entertainment Inc., Tokyo (JP)

(72) Inventors: Jun Yen Leung, London (GB); Maurizio Cerrato, London (GB); Lawrence Martin Green, London (GB)

(21) Appl. No.: 19/455,128

(22) Filed: Jan. 21, 2026

(30) Foreign Application Priority Data
Jan. 22, 2025 (GB) 2500864.0

(51) Int. Cl. H04W 12/06; H04W 12/48

(52) U.S. Cl. CPC H04W 12/06; H04W 12/48

(57) ABSTRACT

A method of direct wireless connection between two devices comprises activating a first device to which a second, peripheral device is to be wirelessly connected; establishing communication between the first device and an app on an intermediary device, the app being authorised to make connections for the first device; the app receiving a request from the second device to connect to the first device; the app approving the request; the app linking the first device to the second device, the first device being configured to accept the link from the app; and the first device and the second device subsequently connecting independent of the app, based on the link.

### CROSS-REFERENCE TO RELATED APPLICATIONS

This application claims priority to United Kingdom Application No. 2500864.0, filed on Jan. 22, 2025, the contents of which are incorporated herein by reference.

### TECHNICAL FIELD

The present disclosure relates to a controller method and apparatus.

### BACKGROUND

Many modern devices provide wireless interfaces, enabling the device itself to omit some or all controls on the device itself. For devices such as a television, the connection between the remote control and the television is passive; the assumption is that there is only one remote control that transmits instructions in the format the TV recognises, and so the TV can permanently scan for such instructions without the need to explicitly link TV and remote control.

By contrast, for other devices, a peripheral may be optional, or generic, or operating within a crowded radio environment where it is beneficial or necessary to perform an explicit link between the device and the peripheral.

If, for example, one purchases a Bluetooth® mouse for a computer, how does one control the computer to link it to that mouse, without a mouse to start with? This so-called chicken-and-egg situation can be resolved either with another mouse or a mouse proxy (e.g. a touch pad or touch screen), or by including a port on the mouse to enable a temporary wired connection, but therefore still requires an alternative input mechanism to be available. This limits the flexibility of design for devices to be linked together straight out of the box without additional inputs.

Embodiments of the present disclosure seek to address or mitigate this problem.

### SUMMARY

Various aspects and features of the present disclosure are defined in the appended claims and within the text of the accompanying description.

In a first aspect, a method of direct wireless connection between two devices is provided in accordance with claim 1.

In another aspect, an intermediary device is provided in accordance with claim 12.

In another aspect, a first device is provided in accordance with claim 14.

In another aspect, a system is provided in accordance with claim 16.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a system in accordance with embodiments of the present description.

FIG. 2 is a schematic diagram of a first device and intermediary device in accordance with embodiments of the present description.

FIG. 3 is a schematic diagram of a first device and intermediary device in accordance with embodiments of the present description.

FIG. 4 is a flow diagram of a method of direct wireless connection between two devices in accordance with embodiments of the present description.

### DETAILED DESCRIPTION

A controller method and apparatus are disclosed. In the following description, a number of specific details are presented in order to provide a thorough understanding of the embodiments of this disclosure. It will be apparent to a person skilled in the art that these specific details need not be employed to practice aspects of this disclosure. Specific details known to the person skilled in the art are omitted for the purposes of clarity where appropriate.

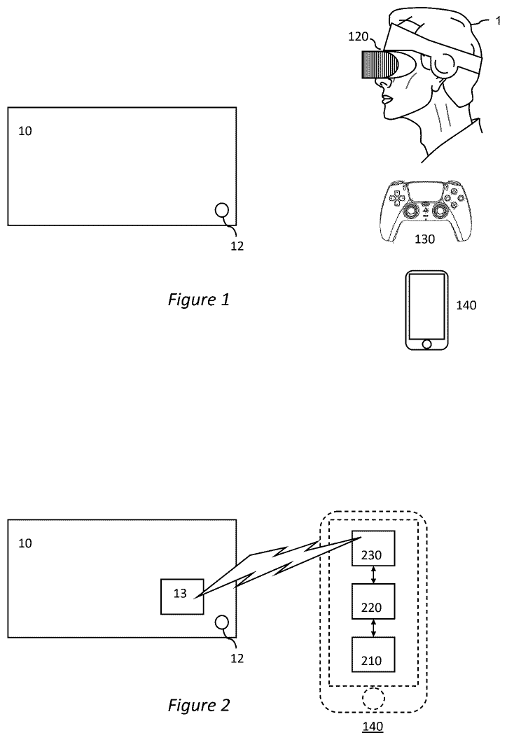

Referring now to the drawings, wherein like reference numerals designate identical or corresponding parts throughout the several views, FIG. 1 shows an entertainment device 10, potentially with a physical interface with a single button or less than three or two buttons—such as an on/off button 12—and a wireless communication unit 13.

A user 1 may have one or more peripheral devices they wish to connect to the entertainment device, such as for example a head mounted display 120, a hand held controller 130, or a keyboard or mouse (not shown).

In addition, the user has a phone 140.

Referring now to FIG. 2, in embodiments of the present description, the phone comprises an app 210, executable on a processor 220 of the phone, that interacts with a wireless protocol of a transmitter 230. As a non-limiting example, the protocol may be Bluetooth®.

The entertainment device 10 can be configured to pre-authorise a wireless connection with the phone using the app (e.g. a Bluetooth link or pairing) using one of the techniques described elsewhere herein.

The app in turn provides a user interface suitable for optionally prompting or polling for peripheral devices, and for receiving and accepting (or refusing) pairing requests.

Notably, the app can be used to receive and accept pairing requests for peripheral devices seeking to connect to the entertainment device. The phone and the app can then forward the pairing/connection request to the entertainment device via its own connection.

The entertainment device can be configured to accept a pairing/connection requested by the app in this manner.

The phone/app can then act as an intermediary as needed until the entertainment device and peripheral device are paired and able to communicate directly and independently of the phone.

The phone and app can include a lightweight public server that establishes a connection between the entertainment device and the peripheral device that can then continue independently of the phone.

This server can tell both the entertainment device and the peripheral its wireless address, and receive their wireless addresses in turn. The server can then tell each device what the address of the other device is, so that they can communicate directly.

As an example, the entertainment device may use any standard Bluetooth human interface device (HID) protocol, but optionally may use any wireless protocol (Bluetooth or otherwise), provided the entertainment device and peripheral support it.

In operation, firstly the user turns on entertainment device 10, or in some other manner activates it or indicates their presence to it, for example by pressing a button or connecting power.

Secondly, the app on the phone establishes a connection with the entertainment device, as detailed elsewhere herein, and establishes an address or port state of the first device used by the desired wireless protocol for direct communications between two devices.

Thirdly, the user turns on peripheral 130, or in some other manner activates it or indicates their presence to it, for example by pressing a button or connecting power.

Fourthly, the app receives a request for connection from the peripheral device. If it is the intended device, the user approves it. The app then establishes an address or port state of the peripheral device used by the desired wireless protocol for direct communications between two devices.

Fifthly, after approval the app sends a pairing/connection request to the entertainment device, specifying the wireless address or port state of the peripheral device. The entertainment device is configured to accept such requests from the app.

The app may also act as a bridge between the entertainment device and peripheral as needed until independent communication is possible, for example providing the address or port state of the first device to the peripheral device so it can respond to a handshake from the entertainment device, if this is not part of the handshake process (or would normally be part of the process but was already conducted between the entertainment device and the app).

The first device and peripheral device may optionally recognise that the address or port information is being received first from the app and then from the other device, and update their source information accordingly as part of the process of establishing independent communication.

Finally, the entertainment device and peripheral are able to communicate independently of the app.

It will be appreciated that entertainment device 10 is merely exemplary of any device capable of wireless connection to a peripheral that has an insufficient user interface to achieve this in at least one mode of operation or interaction. Hence for example the device may have a user interface that is displayed on a TV screen, but requires navigation with a controller, but a controller is not yet connected. Similarly, the user may not be able to access that element of the UI until a controller is connected, or may for example simply not know how to access that element of the UI (or may not have e.g. parental consent to access general settings, which happen to include, among others, that element of the UI).

Similarly hand held controller 130 is merely exemplary of any peripheral capable of wireless connection to a device such as the entertainment device 10. Indeed optionally the device need not be a peripheral per se, but may be a peer device or a complementary part of a wider system. References herein to a peripheral device can be understood to encompass such equivalents.

As noted previously, the entertainment device can be configured to pre-authorise a wireless connection with the phone using the app. Given that the entertainment device may not initially have any means to set this authorisation up via a user interface (thus causing the problem with connecting the peripheral), this can be achieved ‘out of the box’ in one of several ways.

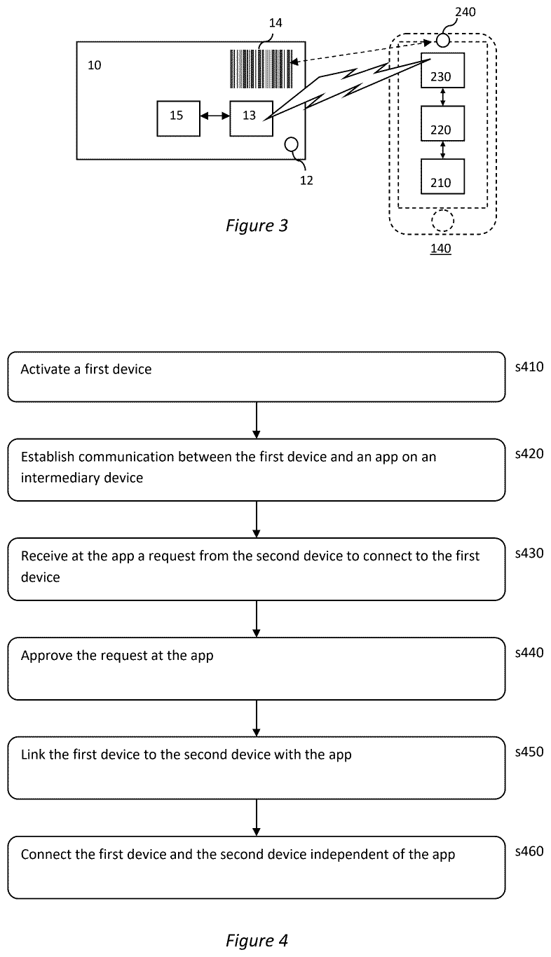

In some embodiments of the present description, referring now to FIG. 3 the entertainment device comprises a unique identifier, such as a serial number, which may be provided as a numeric or alphanumeric sequence, or machine readable format such as a barcode or QR code 14, either on the device, its packaging, and/or its documentation.

The app on the phone can read this unique identifier, for example using a camera 240. This proves that the camera is in physical proximity to the entertainment device. Optionally, the user may also have to create and/or log into a user account (optionally an account to be subsequently associated with the entertainment device) to confirm their identity first.

Meanwhile a processor 15 of the entertainment device 10 has access to a copy of this unique number provided during manufacture (e.g. during initial install of an operating system, BIOS, and/or ROM or the like).

When the entertainment device is activated it is optionally ready by default to accept wireless connections/pairings from a device that knows its serial number. Optionally this acceptance may be for a limited period, e.g. 1, 2, 3, 5, or 10 minutes after activation. Activation may comprise simply turning the device on, or using a further physical input configured to indicate this activation, optionally only during a limited initial period after the device is turned on. Subsequently, once access to a UI of the entertainment device is possible, optionally this default action may be deactivated, or only become active if no suitable peripheral is found after a predetermined period (e.g. in the event that an old peripheral broke and needed replacement, after notionally turning off this facility or being unable to access it).

The entertainment device may either wait for a communication from the phone/app (e.g. a polling request by the phone) and/or it may transmit a polling request itself. In either case the phone/app can transmit the unique identifier as part of its communication.

Optionally, the phone can respond to a poll by the entertainment device with its capability to act as a bridge to other peripherals, and/or as a HID UI device, and include the unique identifier.

Alternatively or in addition, optionally the phone does not transmit the unique identifier in its own poll, as this may enable snooping by other devices in the area. When the entertainment device responds to the poll, it can then send the unique identifier.

In any event, the entertainment device compares the received unique identifier with the one it has stored, and if they match then the entertainment device trusts the app, at least for this session, or for a predetermined period of time, to act as a bridge to similarly trusted other peripherals.

The phone may initially communicate with the entertainment device either through the same wireless protocol as will be used by the peripheral, or optionally via a different protocol. This latter may be the case if the wireless protocol used by the peripheral does not easily allow for the initial sharing of the unique identifier, for example. Hence for example the phone may instead use as appropriate WiFi Direct® or NFC®, Bluetooth® or potentially a wired connection such as USB if available, when seeking to connect using a different one of these or another protocol.

Whilst the authorisation of the app may use a unique identifier, optionally simply the presence of the app in direct wireless communication with the entertainment device (and hence physical proximity) may be assumed authorised for some devices. Typically these will be domestic devices such as videogame consoles, white goods such as fridges, washing machines, or ovens, or audio-video equipment such as wireless speakers or amplifiers, where physical proximity implies authorised access. This may apply to any device, for example for a limited time period after a predetermined button on the device is pressed, or the device is powered on. Further optionally, this approach may require the first device and phone app to maintain communications (e.g. repeated polls, presence adverts, keep-alive signals, or the like) for a predetermined period of time before treating the phone as authorised, so that it is more difficult for unwanted actors to be authorised on a presence-only basis.

In either case, again optionally the app may only attempt communication with such a device once the user has been authorised, for example by logging into/creating an account with a server associated with the first (and/or optionally second) device (e.g. operated by a manufacturer or distributor of the device).

### Variant Embodiments

Some devices use non-standard wireless protocols, such as protocols configured by a particular manufacturer. In this case, the app may be configured to use the same non-standard protocol. Similarly, some devices use standard wireless protocols, but incompletely or in non-standard ways. In either case, the app may comprise configuration data for different devices (entertainment devices and/or peripherals) in order to operate as that device intends. Optionally in some cases the user may need to specify the device to the app via a UI of the app, if the device itself does not identify itself uniquely or adequately as a precursor to non-standard wireless operation.

As noted above, some devices or peripherals may not be fully compliant with a wireless protocol, or only implement those parts essential for normal operation of the peripheral. In some such cases is may be necessary for the app to spoof the identity of the entertainment device to the peripheral, so that it connects directly as if to the entertainment device, whilst optionally also spoofing the identity of the peripheral to the entertainment device, so that it also connects as if to the peripheral. The app can then break the connections, allowing the entertainment device and/or peripheral to re-establish what appears to be the same connection, but this time directly.

Some devices require proof that a peripheral is legitimate, for example by use of a digital signature. Typically this proof is established either during or after an initial handshake and so may occur after the methods herein relating to the operation of the app are complete. Alternatively, the device may allow the app to operate and communicate in the disclosed manner, but only for the purposes relating to the methods herein as a means to connect to a legitimate device with separate

authentication mechanism(s). Hence the first device may limit interaction with the phone app solely to linking the first device with a second device, in the absence of further authentication information.

Optionally there may be several levels of authentication and interaction; for example some additional interaction may be available for a user who has logged in to a relevant account on a server, and similarly additional interaction may be available when a digital signature is included or obtained (e.g. form such a server). Hence further optionally, the app may comprise the relevant digital signature if permitted by the signature holder. In this case, typically the device will still also need the digital signature as well in order to subsequently communicate directly with its counterpart.

It will be appreciated that references herein to the app or the phone app typically encompass those additional elements of the phone used by the app to perform required functions, such as wireless communications or reading bar codes. Hence whilst the app itself may be a downloadable or stored piece of software, it operates within the environment of the phone to implement the features herein. In this regard it will be further appreciated that the phone may be considered a suitably equipped computer. In this regard it will also be appreciated that a tablet or laptop may similarly function in a similar manner to a phone for the purposes of the techniques herein, for example having Bluetooth® or other direct wireless capabilities and optionally a camera for reading a unique identifier or the like. Hence more generally the phone is an example of an intermediary device herein, and the phone app may be an intermediary device app or intermediary app. Hence also references to the phone or intermediary device performing an action, and the app performing an action, may be considered interchangeable.

In some embodiments, a method of direct wireless connection between two devices (e.g. a method of establishing direct wireless connection between two devices) comprises the following steps.

In a first step s410, activate a first device to which a second, peripheral device is to be wirelessly connected, as described elsewhere herein.

In a second step s420, establish communication between the first device and an app on an intermediary device, the app being authorised to make connections for the first device, as described elsewhere herein.

In a third step s430, receive at the app a request from the second device to connect to the first device, as described elsewhere herein.

In a fourth step s440, approve the request at the app, for example via user confirmation, as described elsewhere herein.

In a fifth step s450, link the first device to the second device with the app, the first device being configured to accept the link from the app - for example without requiring a user input to set this configuration or request trust of the app, or no further configuration than is possible without use of the second device, or no further configuration than is possible without use of another peripheral, as described elsewhere herein. In some contexts (e.g. Bluetooth®), linking may comprise pairing.

In a sixth step s460, the first device and the second device subsequently connecting (or equivalently continuing their new connection) independent of the app, as described elsewhere herein.

It will be apparent to a person skilled in the art that variations in the above method corresponding to operation of the various embodiments of the apparatus as described and claimed herein are considered within the scope of the present disclosure, including but not limited to that:
the step of the app linking the first device to the second device comprises the step of receiving an address or port state from the second device and providing it to the first device so that the first device can send a communication direct to the second device, as described elsewhere herein;
the step of the app linking the first device to the second device comprises the step of receiving an address or port state from the first device and providing it to the second device so that the second device can send a communication direct to the first device, as described elsewhere herein;
the second device is a prospective peripheral of the first device (i.e. one that could be a peripheral if connected as such), as described elsewhere herein;
the app on the intermediary device is authorised to make connections for the first device by virtue of a proximity to the device as evidenced by direct wireless communication with the first device, as described elsewhere herein;
authorising the app on the intermediary device to make connections for the first device comprises the steps of accessing, by the app, a unique identifier physically associated with the first device, the app communicating the unique identifier to the first device, the first device comparing the communicated unique identifier with an internal record of the unique identifier, and if the unique identifiers match, authorising the app, as described elsewhere herein;
authorising the app on the intermediary device to make connections for the first device comprises the step of a user of the app logging into an account associated with the app, as described elsewhere herein;
the app selects a non-standard implementation of a wireless communication standard in response to the type of one or both of the first and second devices, as described elsewhere herein;
the app spoofs the identity of at least one of the first or second devices when linking to the other device, as described elsewhere herein; and
the first device limits interaction with the app to linking the first device with a second device, in the absence of further authentication information, as described elsewhere herein.

It will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the equivalent device. Separately, such a computer program may be transmitted via data signals on a network such as an Ethernet, a wireless network, the Internet, or any combination of these or other networks.

Accordingly, in some embodiments, an intermediary device (for example phone 140), comprises the following.

A processor (for example processor 220), configured in operation (for example by app 210) to implement a method of direct wireless connection between two devices, comprising:

Establishing communication between a first device and an app, the app being authorised to make connections for the first device,, as described elsewhere herein; the app receiving a request from the second device to connect to the first device, as described elsewhere herein; the app approving the request, as described elsewhere herein; and the app linking the first device to the second device, the first device being configured to accept the link from the app, so that the first device and the second device can subsequently connect independent of the app, based on the link, as described elsewhere herein.

Instances of one or more embodiments implementing the methods and techniques described herein (for example by use of suitable software instruction) are envisaged within the scope of the application, including but not limited to that the processor is further configured in operation to implement the steps of accessing, by the app, a unique identifier physically associated with the first device, the app communicating the unique identifier to the first device, and the app receiving authorisation from the first device, if the communicated unique identifier matches an internal record of the unique identifier held by the first device, as described elsewhere herein. Similarly, in one or more embodiments of the present description, a first device (for example entertainment device 10), comprises the following.

A processor 15, configured in operation (for example by suitable software instruction) to implement a method of direct wireless connection between two devices, comprising receiving a communication from an app of an intermediate device, providing information for linking to a second device, as described elsewhere herein, accepting the communication as a request to link to the second device, as described elsewhere herein, and attempting to establish a direct link with the second device based on the provided information, as described elsewhere herein. One or more embodiments implementing the methods and techniques described herein (for example by use of suitable software instruction) are envisaged within the scope of the application, including but not limited to that the processor is configured to determine whether the app is authorised, and the processor is configured to accept the communication as a request to link to the second device if the app is so authorised.

In one or more embodiments of the present description, a system comprises the intermediary device (for example the phone and app), as described elsewhere herein, the first device (for example the entertainment device) as described elsewhere herein, and a second device (for example a controller 130 or other peripheral) to be wirelessly linked to the first device by the intermediary device, as described elsewhere herein.

The foregoing discussion discloses and describes merely exemplary embodiments of the present disclosure. As will be understood by those skilled in the art, embodiments disclosed may be embodied in other specific forms without departing from the spirit or essential characteristics thereof. Accordingly, the disclosure intended to be illustrative, but not limiting of the scope of the disclosures, as well as other claims. The disclosure, including any readily discernible variants of the teachings herein, defines, in part, the scope of the foregoing claim terminology such that no inventive subject matter is dedicated to the public.

1.-16. (canceled)

17. A method of direct wireless connection between two devices, comprising:
establishing communication between a first device and an application on an intermediary device;
receiving a request from a second device to connect to the first device;
approving the request; and
transmitting link data to the first device configured to enable connection between the first device and the second device independent of the application on the intermediary device.

18. The method of claim 17, comprising:
receiving an address or port state of the second device from the second device, wherein transmitting the link data to the first device configured to enable connection between the first device and the second device independent of the application on the intermediary device comprise:
providing the address or port state of the second device to the first device.

19. The method of claim 17, comprising:
receiving an address or port state of the first device from the first device; and
providing the address or port state of the first device to the second device.

20. The method of claim 17, wherein the second device is a peripheral of the first device.

21. The method of claim 17, comprising:
transmitting a wireless communication with the first device;
determining, based on the transmitted wireless communication, a proximity of the intermediary device and the first device; and
determining, based on the proximity of the intermediary device and the first device, that the application on the intermediary device is authorized to make connections for the first device, wherein establishing communication between the first device and the application on the intermediary device occurs in response to determining that the application on the intermediary device is authorized to make connections for the first device.

22. The method of claim 17, comprising:
accessing a unique identifier physically associated with the first device;
transmitting the unique identifier to the first device; and
determining, based on transmitting the unique identifier to the first device, that the application on the intermediary device is authorized to make connections for the first device, wherein establishing communication between the first device and the application on the intermediary device occurs in response to determining that the application on the intermediary device is authorized to make connections for the first device.

23. The method of claim 17, comprising:
receiving user login credentials for an account associated with the application on the intermediary device; and
determining, based on receiving the user login credentials for the account associated with the application on the intermediary device, that the application on the intermediary device is authorized to make connections for the first device, wherein establishing communication between the first device and the application on the intermediary device occurs in response to determining that the application on the intermediary device is authorized to make connections for the first device.

24. The method of claim 17, comprising:
detecting a device type of the first device; and
in response to detecting the device type of the first device, selecting a wireless communication standard for transmitting the link data to the first device, wherein transmitting the link data to the first device comprises:
transmitting data to the first device using the selected wireless communication standard.

25. The method of claim 17, wherein transmitting the link data to the first device configured to enable connection between the first device and the second device independent of the application on the intermediary device comprises:
transmitting the link data to the first device while spoofing an identity of the second device.

26. The method of claim 17, comprising:
determining a status of authentication information; and
in response to determining the status of the authentication information, canceling a communication link between the application on the intermediary device and the first device after transmitting the link data to the first device configured to enable connection between the first device and the second device independent of the application on the intermediary device.

27. One or more non-transitory computer storage media encoded with computer program instructions that when executed by one or more computers cause the one or more computers to perform operations comprising:
establishing communication between a first device and an application on an intermediary device;
receiving a request from a second device to connect to the first device;
approving the request; and
transmitting link data to the first device configured to enable connection between the first device and the second device independent of the application on the intermediary device.

28. The media of claim 27, wherein the operations comprise:
receiving an address or port state of the second device from the second device, wherein transmitting the link data to the first device configured to enable connection between the first device and the second device independent of the application on the intermediary device comprise:
providing the address or port state of the second device to the first device.

29. The media of claim 27, wherein the operations comprise:
receiving an address or port state of the first device from the first device; and
providing the address or port state of the first device to the second device.

30. The media of claim 27, wherein the second device is a peripheral of the first device.

31. The media of claim 27, wherein the operations comprise:
transmitting a wireless communication with the first device;
determining, based on the transmitted wireless communication, a proximity of the intermediary device and the first device; and
determining, based on the proximity of the intermediary device and the first device, that the application on the intermediary device is authorized to make connections for the first device, wherein establishing communication between the first device and the application on the intermediary device occurs in response to determining that the application on the intermediary device is authorized to make connections for the first device.

32. The media of claim 27, wherein the operations comprise:
accessing a unique identifier physically associated with the first device;
transmitting the unique identifier to the first device; and
determining, based on transmitting the unique identifier to the first device, that the application on the intermediary device is authorized to make connections for the first device, wherein establishing communication between the first device and the application on the intermediary device occurs in response to determining that the application on the intermediary device is authorized to make connections for the first device.

33. The media of claim 27, wherein the operations comprise:
receiving user login credentials for an account associated with the application on the intermediary device; and
determining, based on receiving the user login credentials for the account associated with the application on the intermediary device, that the application on the intermediary device is authorized to make connections for the first device, wherein establishing communication between the first device and the application on the intermediary device occurs in response to determining that the application on the intermediary device is authorized to make connections for the first device.

34. The media of claim 27, wherein the operations comprise:
detecting a device type of the first device; and
in response to detecting the device type of the first device, selecting a wireless communication standard for transmitting the link data to the first device, wherein transmitting the link data to the first device comprises:
transmitting data to the first device using the selected wireless communication standard.

35. The media of claim 27, wherein transmitting the link data to the first device configured to enable connection between the first device and the second device independent of the application on the intermediary device comprises:
transmitting the link data to the first device while spoofing an identity of the second device.

36. A system comprising:
one or more computers and one or more storage devices on which are stored instructions that are operable, when executed by the one or more computers, to cause the one or more computers to perform operations comprising:
establishing communication between a first device and an application on an intermediary device;
receiving a request from a second device to connect to the first device;
approving the request; and
transmitting link data to the first device configured to enable connection between the first device and the second device independent of the application on the intermediary device.
